(19) United States
(12) Patent Application Publication
(10) Pub. No.: US 2024/0364365 A1
(43) Pub. Date: Oct. 31, 2024

(54) ELECTRONIC CONTROL APPARATUS

(71) Applicant: DENSO CORPORATION, Kariya-city (JP)

(72) Inventors: Akiyoshi MATSUMOTO, Kariya-city (JP); Nobuhisa SHIMIZU, Kariya-city (JP); Mitsuru NAKAMURA, Kariya-city (JP)

(21) Appl. No.: 18/645,211

(22) Filed: Apr. 24, 2024

(30) Foreign Application Priority Data
Apr. 25, 2023 (JP) 2023-071629

(51) Int. Cl. H04B 1/00; H04B 1/16

(52) U.S. Cl. CPC H04B 1/0007; H04B 1/1607

(57) ABSTRACT

In an electronic control apparatus, a processing unit is configured to perform processing on one or more targets. A communication unit is configured to communicate with a communication device using a predetermined communication protocol to accordingly receive a first startup signal for startup of the processing unit from the communication device. The communication unit is configured to output, in response to receiving the first startup signal from the communication device, a second startup signal for startup of the processing unit. A voltage controller is configured to supply, in response to receiving one of the second startup signal and a third startup signal for startup of the processing unit outputted from an external device, a startup voltage based on a power voltage to the processing unit to accordingly start up the processing unit.

### CROSS REFERENCE TO RELATED APPLICATION

This application is based on and claims the benefit of priority from Japanese Patent Application No. 2023-071629 filed on Apr. 25, 2023, the disclosure of which is incorporated in its entirety herein by reference.

### TECHNICAL FIELD

The present disclosure relates to electronic control apparatuses.

### BACKGROUND

Japanese Patent Publication No. 5195943 discloses an electronic control apparatus that includes a communication driver, a communication-start detection circuit, a latch circuit, OR gates, a regulator, a microcomputer, and a semiconductor circuit board of a power IC.

When receiving data using Controller Area Network (CAN) protocol, the communication driver transmits the received data to the microcomputer.

When the microcomputer outputs data to the communication driver, the communication driver receives the outputted data, and outputs, to a communication bus, a dominant signal based on the received data outputted from the microcomputer. When detecting the dominant signal on the communication bus, the communication-start detection circuit outputs a communication start signal to the regulator through the OR gate and the latch circuit as a power-on permission signal.

When the power-on permission signal inputted thereto through the OR gate has a high level, the regulator operates to supply a power voltage to the microcomputer.

In particular, the regulator, the communication driver, the communication-start detection circuit, and the latch circuit are mounted on the semiconductor circuit board.

### SUMMARY

The inventor considers that the configuration disclosed in the Patent Publication may result in the size of the semiconductor circuit board relatively increasing, because e communication driver, the communication-start detection circuit, the latch circuit, and one or more other peripheral circuits are respectively mounted on the semiconductor circuit board as separate individual components. This may therefore result in the size of the electronic control apparatus being greater.

The present disclosure seeks to provide electronic control apparatuses with a smaller size.

An exemplary aspect of the present disclosure provides an electronic control apparatus. The electronic control apparatus includes a processing unit, a communication unit, and a voltage controller. The processing unit is configured to perform processing on one or more targets. The communication unit is configured to communicate with a communication device using a predetermined communication protocol to accordingly receive a first startup signal for startup of the processing unit from the communication device. The communication unit is configured to output, in response to receiving the first startup signal from the communication device, a second startup signal for startup of the processing unit. The voltage controller is configured to supply, in response to receiving one of the second startup signal and a third startup signal for startup of the processing unit outputted from an external device, a startup voltage based on a power voltage to the processing unit to accordingly start up the processing unit.

The communication unit of the electronic control apparatus therefore has both (i) a first function of communicating with the communication device and (ii) a second function of outputting the third startup signal for startup of the processing unit. This configuration results in the first function and the second function being integrally installed in a single component, i.e., the communication unit, without being respectively installed in separate individual components, resulting in the electronic control apparatus having a smaller size.

### BRIEF DESCRIPTION OF THE DRAWINGS

Other aspects of the present disclosure will become apparent from the following description of embodiments with reference to the accompanying drawings in which:

FIG. 1 is a circuit block diagram schematically illustrating a configuration of a system in which an electronic control apparatus according to an exemplary embodiment is installed;

FIG. 2 is a flowchart schematically illustrating a first normal start-up routine of an SoC triggered by an external ECU;

FIG. 3 is a flowchart schematically illustrating a second normal start-up routine of the SoC triggered by a communication device;

FIG. 4 is a first normal shutdown routine of the SoC triggered by the external ECU;

FIG. 5 is a flowchart schematically illustrating a second normal shutdown routine of the SoC triggered by the communication device;

FIG. 6 is a first reprogramming start-up routine of the SoC triggered by the external ECU;

FIG. 7 is a second reprogramming start-up routine of the SoC triggered by the communication device; and

FIG. 8 is a flowchart schematically illustrating a shutdown routine after completion of an OTA reprogramming task.

### DETAILED DESCRIPTION OF EMBODIMENT

The following describes an exemplary embodiment of the present disclosure with reference to accompanying drawings. In the exemplary embodiment and its modifications, descriptions of like or equivalent parts, to each of which an identical or similar reference character is assigned, are omitted or simplified to avoid redundant description.

The following describes an electronic control apparatus, which has a smaller size, can be used for systems, such as a system installed in a vehicle. The following describes such a system 1 first.

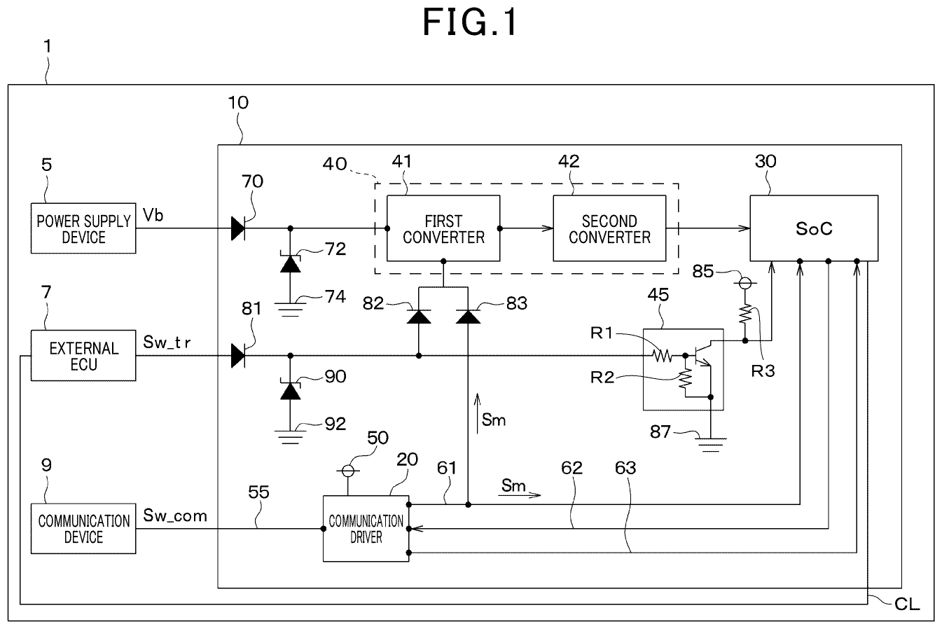

The system 1 includes, as illustrated in FIG. 1, a power supply device 5, an external electronic control unit (ECU) 7, a communication device 9, and an electronic control unit (ECU) 10 serving as the electronic control apparatus according to the first embodiment.

The power supply device 5 is disposed outside the ECU 10 and connected to the ECU 10. The power supply device 5 is configured to supply a voltage to the ECU 10. The external ECU 7 is disposed outside the ECU 10 and connected to the ECU 10. The communication device 9 is disposed outside the ECU 10 and connected to the ECU 10. The communication device 9 communicates with the ECU 10 as described hereinafter.

The ECU 10 is configured to start up based on the voltage supplied thereto from the power supply device 5 in response to a signal sent from the external ECU 7 or the communication device 9. After the startup, the ECU 10 performs various tasks on information and/or for one or more controlled targets. For example, the ECU 10 performs an image-processing operation based on images captured by unillustrated one or more vehicular cameras. Additionally, the ECU 10 performs an updating task of updating itself, such as one or more programs and/or information stored therein, and a shutdown task of shutting itself down.

The following describes a detailed configuration of the ECU 10 included in the system configured set forth above.

The ECU 10 includes a communication driver 20, an SoC (System on a chip) 30, a converter module 40 comprised of first and second converters 41 and 42, a second converter 42, a digital transistor 45, a power source 50, a communication line, i.e., a communication bus, 55, a first conductor wiring 61, a second conductor wiring 62, and a third conductor wiring 63. The ECU 10 additionally includes a diode 70, a Zener diode 72, a ground 74, a first diode 81, a second diode 82, and a diode 83. The ECU 10 includes a power source 85, a ground 87, a Zener diode 90, and a ground 92.

The power source 50 and diode 83 are provided for the communication driver 20. The diode 70, Zener diode 72, and ground 74 are provided for the power supply device 5. The first diode 81, second diode 82, Zener diode 90, and ground 92 are provided for the external ECU 7. The power source 85 and ground 87 are provided for the digital transistor 45.

The communication driver 20 includes, for example, a communication circuit and a signal input/output (I/O) circuit, and is configured to operate based on a voltage supplied from the power source 50. The communication driver 20 is connected to the communication device 9 through the communication line 55. The communication driver 20 is configured to communicate with the communication device 9 using a predetermined communication protocol, such as a Controller Area Network (CAN) protocol or a Local Interconnect Network (LIN) protocol. The communication driver 20 communicates, by wire, with the communication device 9, but the present disclosure is not limited thereto. Specifically, the communication driver 20 can wirelessly communicate with the communication device 9.

The SoC 30 is comprised mainly of a microcomputer on a chip. Specifically, the SoC 30 is comprised of a chip and a microcomputer mounted on the chip; the microcomputer includes a CPU, a ROM, a flash memory, a RAM, an I/O interface, and bus lines connecting these components to one another. The first to third conductor wirings 61 to 63 are parallelly connected to the SoC 30. The SoC 30 is connected to the communication driver 20 through the first to third conductor wirings 61 to 63. The SoC 30 is configured to start up based on a voltage supplied thereto from the power supply device 5 through the diode 70 and the first and second converters 41 and 42 in response to a signal outputted from the external ECU 7 or the communication device 9. After the startup, the SoC 30 is configured to execute one or more programs stored therein to accordingly perform various tasks on information and/or for one or more controlled targets. For example, the SoC 30 performs an image-processing task based on images captured by the unillustrated one or more vehicular cameras. Additionally, the SoC 30 performs an Over-The-Air (OTA) reprogramming task of programs stored therein and a shutdown task of shutting itself down. The SoC 30 can perform the OTA reprogramming task of updating software and/or information installed therein through wireless communications.

The first converter 41 includes, for example, a direct-current (DC)-DC converter and/or a regulator that is comprised of power-converter switches. The first converter 41 is connected to the diode 70. A power voltage Vb supplied from the power supply device 5 is applied to the first converter 41 through the diode 70. The first converter 41 is connected to the external ECU 7 through the first and second diodes 81 and 82. The first converter 41 is connected to the communication driver 20 through the diode 83 and the first conductor wiring 61. The first converter 41 is configured to perform on-off operations of the power-converter switches of the DC-DC converter or the regulator in accordance with a signal outputted from the external ECU 7 and the communication driver 20 to accordingly convert, i.e., step down, the power voltage Vb to a converted voltage Vb1. The first converter 41 is additionally configured to supply the converted voltage Vb1 to the second converter 42. A connecting point between the first converter 41 and the diode 70 is connected to the ground 74 through the Zener diode 72. This configuration protects the ECU 10 against surge currents due to on-off operations of the first converter 41 and/or static electricity.

The second converter 42 includes, for example, a DC-DC converter and/or a regulator that is comprised of power-converter switches. The second regulator 42 is configured to perform on-off operations of the power-converter switches of the DC-DC converter and/or the regulator to accordingly adjust the converted voltage Vb1 to an adjusted voltage Vb2 that enables start-up of the SoC 30. The second converter 42 is additionally configured to apply the adjusted voltage Vb2 to the SoC 30, resulting in the SoC 30 starting up.

The digital transistor 45, which is comprised of a bipolar transistor containing a series base resistor R1 and a base-emitter resistor R2, has a base terminal, a collector terminal, and an emitter terminal. The base terminal of the digital transistor 45 is connected to the external ECU 7 through the first diode 81. The collector terminal of the digital transistor 45 is connected to the SoC 30, and also is connected to the power source 85 through a pullup resistor R3. The emitter terminal of the digital transistor 45 is connected to the ground 87. A connection point between the first diode 81 and the base terminal of the digital transistor 45 is connected to the ground 92 through the Zener diode 90. This configuration protects the ECU 10 against surge currents due to signals outputted from the external ECU 7 and/or static electricity.

Next, the following describes a first normal startup routine for startup of the SoC 30 and a first normal shutdown routine for shutdown, i.e., stop, of the SoC 30, which is triggered by the external ECU 7.

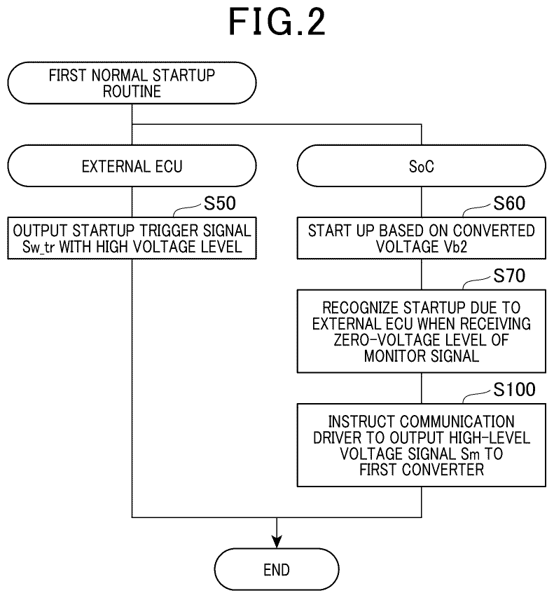

First, the following describes the first normal start-up routine with reference to FIGS. 1 and 2.

Note that, as illustrated in FIG. 1, the signal outputted from the external ECU 7, which is used for startup of the SoC 30, will be referred to as a startup trigger signal Sw_tr.

For startup of the SoC 30, the external ECU 7 outputs, to the ECU 10, the startup trigger signal Sw_tr that is a voltage signal with a high level in step S50 of the first normal start-up routine illustrated in FIG. 2. The startup trigger signal Sw_tr having the high voltage level is outputted to the first converter 41 through the first and second diodes 81 and 82. In response to receiving the startup trigger signal Sw_tr having the high voltage level, the first converter 41 convert the power voltage Vb to the voltage Vb1, and supplies the converted voltage Vb1 to the second converter 42. In response to receiving the converted voltage Vb1, the second converter 42 adjusts the converted voltage Vb1 to the voltage Vb2 that enables start-up of the SoC 30. Then, the second converter 42 supplies the converted voltage Vb2 to the SoC 30, resulting in the SoC 30 starting up in step S60 of the first normal start-up routine.

At that time, when no trigger signal Sw_tr having the high voltage level is outputted to the base of the digital transistor 45, the digital transistor 45 is in an off state, so that a predetermined pull-up voltage of the power source 85 is inputted to the SoC 30 as a monitor signal. This enables the SoC 30 determines, based on the voltage level, i.e., the pull-up voltage level of the monitor signal, that no trigger signal Sw_tr with the high voltage level is outputted toward the SoC 30.

In contrast, when the startup trigger signal Sw_tr having the high voltage level is additionally outputted to the base terminal of the digital transistor 45, the digital transistor 45 is switched from the off state to an on state. The on state of the digital transistor 45 enables a zero-voltage level of the monitor signal to be outputted from the digital transistor 45 to the SoC 30.

When receiving the monitor signal having the zero-voltage level outputted from the digital transistor 45, the SoC 30 recognizes that this startup of the SoC 30 itself is due to the external ECU 7 in step S70 of the first normal startup routine.

When starting up, the SoC 30 executes various programs including a startup program stored therein. Specifically, when executing the start-up program, the SoC 30 instructs the communication driver 20 to output a high-level voltage signal Sm to the first converter 41 through the first conductor wiring 61 in step S100 of the first normal startup routine.

Specifically, as illustrated in FIG. 1, the SoC 30 outputs, to the communication driver 20 through the second conductor wiring 62, a first instruction signal that instructs the communication driver 20 to output the high-level voltage signal Sm. In response to receiving the first instruction signal, the communication driver 20 outputs the high-level voltage signal Sm to the first converter 41 through the first conductor wiring 61 and the third diode 83.

Accordingly, even if the voltage level of the startup trigger signal Sw_tr changes from the high level to the low level due to any cause, the high-level voltage signal Sm is inputted from the third diode 83 to the first converter 41 in place of the high-level startup trigger signal Sw_tr, making it possible to maintain, at the high level, the voltage signal for instructing the first converter 41 to convert the power voltage Vb to the voltage Vb1. This therefore results in the converted voltage Vb1 being continuously applied from the first converter 41 to the second converter 42, making it possible to maintain the startup of the SoC 30. After a predetermined period has elapsed since the startup of the SoC 30, the SoC 30 terminates the startup program to accordingly terminate outputting of the high-level voltage signal Sm from the communication driver 20 to the SoC 30 and the first converter 41.

The startup, i.e., activation, of the SoC 30 in the first normal startup routine, which is triggered by the external ECU 7, has been described.

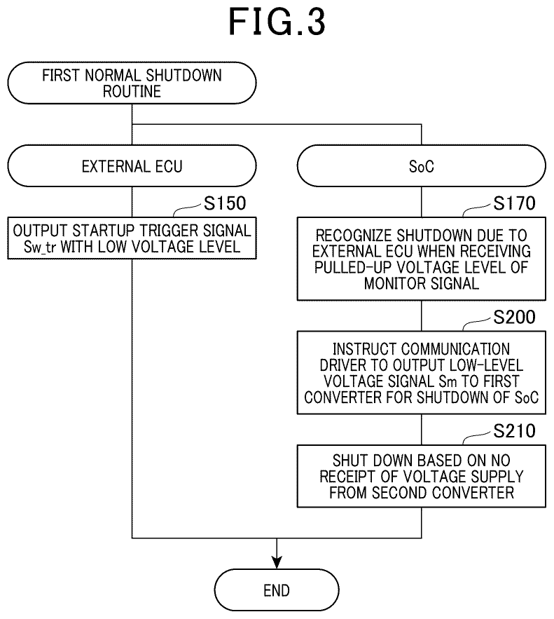

Next, the following describes how the external ECU 7 instructs the SoC 30 to be shut down, i.e., stop, in the first normal shutdown routine with reference to FIGS. 1 and 3.

For stop of the SoC 30, the external ECU 7 outputs, to the ECU 10, the startup trigger signal Sw_tr having a low voltage level in step S150 of the first normal shutdown routine illustrated in FIG. 3. The startup trigger signal Sw_tr having the low voltage level is outputted to the first converter 41 through the first and second diodes 81 and 82. Because, however, the high-level voltage signal Sm has been being outputted from the communication driver 20 to the first converter 41 through the first conductor wiring 61 and the third diode 83, the voltage application from the first converter 41 to the second converter 42 has been being maintained.

The startup trigger signal Sw_tr having the low voltage level is additionally outputted to the base terminal of the digital transistor 45 through the first diode 81, resulting in the digital transistor 45 being switched from the on state to the off state. This off state of the digital transistor 45 results in the pull-up voltage of the power source 85 is inputted to the SoC 30 as the monitor signal. This enables the SoC 30 to determine, based on the voltage level, i.e., the pull-up voltage level of the monitor signal, that no trigger signal Sw_tr with the high voltage level is outputted toward the SoC 30. When receiving the monitor signal having the pull-up voltage level from the digital transistor 45, the SoC 30 recognizes the present situation that requires shutdown of the SoC 30 in step S170 of the first normal shutdown routine.

In response to this recognition, the SoC 30 executes a shutdown program stored therein. Specifically, when executing the shutdown program, the SoC 30 instructs the communication driver 20 to output the voltage signal Sm with a low level to the first converter 41 through the first conductor wiring 61 in step S200 of the first normal shutdown routine.

Specifically, as illustrated in FIG. 1, the SoC 30 outputs, to the communication driver 20 through the second conductor wiring 62, a second instruction signal that instructs the communication driver 20 to output the low-level voltage signal Sm. In response to receiving the second instruction signal, the communication driver 20 changes the voltage level of the voltage signal Sm from the high level to the low level, and outputs the low-level voltage signal Sm to the first converter 41 through the first conductor wiring 61 and the third diode 83. In response to receiving the low-level voltage signal Sm while receiving the startup trigger signal Sw_tr with the low voltage level, the first converter 41 stops conversion of the power voltage Vb, and stops voltage supply to the second converter 42, so that the second converter 42 stops both voltage adjustment and voltage supply to the SoC 30. When determining no receipt of the voltage supply from the second converter 42, the SoC 30 stops execution of the shutdown program, thereafter shutting itself down in step S210 of the first normal shutdown routine.

The shutdown, i.e., deactivation, of the SoC 30 in the first normal shutdown routine, which is triggered by the external ECU 7, has been described.

Next, the following describes a second normal startup routine for startup of the SoC 30 and a second normal shutdown routine for shutdown, i.e., stop, of the SoC 30, which is triggered by the communication device 9.

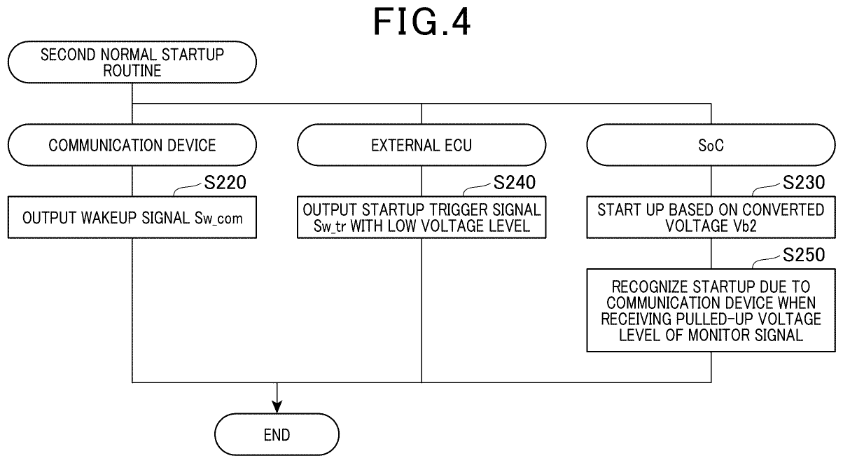

The following describes how the second normal startup routine with reference to FIGS. 1 and 4.

Note that, as illustrated in FIG. 1, the signal outputted from the communication device 9, which is used for startup of the SoC 30, will be referred to as a wakeup signal Sw_com.

For startup of the SoC 30, the communication device 9 outputs, to the ECU 10, the wakeup signal Sw_com to the communication driver 20 through the communication line 55 in step S220 of the second normal start-up routine illustrated in FIG. 4. In response to receiving the wakeup signal Sw_com, the communication driver 20 outputs the high-level voltage signal Sm to the first converter 41 through the first conductor wiring 61 and the third diode 83. In response to receiving the high-level voltage signal Sm, the first converter 41 converts the power voltage Vb to the voltage Vb1, and supplies the converted voltage Vb1 to the second converter 42. In response to receiving the converted voltage Vb1, the second converter 42 adjusts the converted voltage Vb1 to the voltage Vb2 that enables start-up of the SoC 30. Then, the second converter 42 supplies the converted voltage Vb2 to the SoC 30, resulting in the SoC 30 starting up in step S230 of the second normal start-up routine.

At that time, the external ECU 7 outputs the startup trigger signal Sw_tr having the low voltage level to the base terminal of the digital transistor 45 in step S240 of the second normal startup routine, resulting in the digital transistor 45 being maintained in the off state. The off state of the digital transistor 45 results in the pull-up voltage of the power source 85 being inputted to the SoC 30 as the monitor signal. This enables the SoC 30 to determine, based on the voltage level, i.e., the pull-up voltage level of the monitor signal, that no trigger signal Sw_tr with the high voltage level is outputted toward the SoC 30. When receiving the monitor signal having the pull-up voltage level from the digital transistor 45, the SoC 30 recognizes that startup of the SoC 30 itself is due to the communication device 9 in step S250 of the second normal startup routine.

The startup, i.e., activation, of the SoC 30 in the second normal startup routine, which is triggered by the communication device 9, has been described.

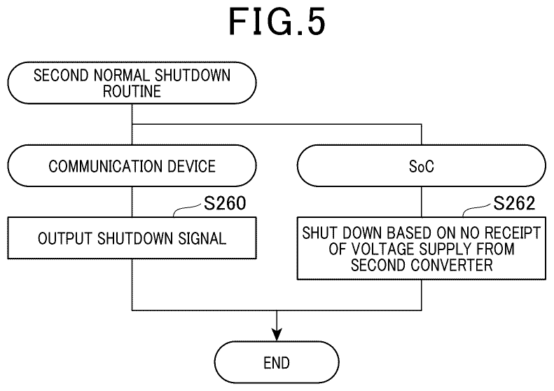

Next, the following describes how the communication device 9 instructs the SoC 30 to be shut down in the second normal shutdown routine with reference to FIGS. 1 and 5.

For shutdown of the SoC 30, the communication device 9 outputs a shutdown signal to the communication driver 20 in step S260 of the second normal shutdown routine illustrated in FIG. 5. In response to receiving the shutdown signal, the communication driver 20 changes the voltage level of the voltage signal Sm from the high level to the low level, and outputs the low-level voltage signal Sm to the first converter 41 through the first conductor wiring 61 and the third diode 83. In response to receiving the low-level voltage signal Sm while receiving the startup trigger signal Sw_tr with the low voltage level, the first converter 41 stops conversion of the power voltage Vb, and stops voltage supply to the second converter 42, so that the second converter 42 stops both voltage adjustment and voltage supply to the SoC 30. When determining no receipt of the voltage supply from the second converter 42, the SoC 30 stops execution of the stop program, thereafter shutting itself down in step S262 of the second normal stop routine.

The shutdown, i.e., deactivation, of the SoC 30 in the second normal shutdown routine, which is triggered by the communication device 9, has been described.

Additionally, the SoC 30 is configured to perform the OTA reprogramming task. In order to instruct the SoC 30 to perform the OTA reprogramming task, the external ECU 7 or the communication device 9 instructs the SoC 30 to start up.

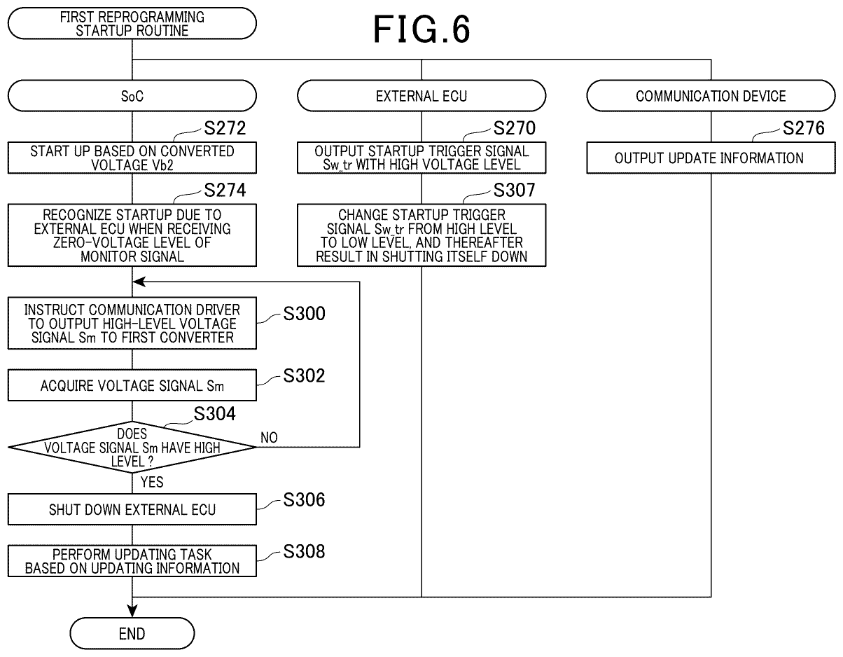

Next, the following describes a first reprogramming startup routine, which is triggered by the external ECU 7 with reference to FIGS. 1 and 6.

For startup of the SoC 30, the external ECU 7 outputs, to the ECU 10, the startup trigger signal Sw_tr having the high voltage level in step S270 of the first reprogramming start-up routine illustrated in FIG. 6. The startup trigger signal Sw_tr having the high voltage level is outputted to the first converter 41 through the first and second diodes 81 and 82. In response to receiving the startup trigger signal Sw_tr having the high voltage level, the first converter 41 convert the power voltage Vb to the voltage Vb1, and supplies the converted voltage Vb1 to the second converter 42. In response to receiving the converted voltage Vb1, the second converter 42 adjusts the converted voltage Vb1 to the voltage Vb2 that enables start-up of the SoC 30. Then, the second converter 42 supplies the converted voltage Vb2 to the SoC 30, resulting in the SoC 30 starting up in step S272 of the first reprogramming start-up routine.

At that time, the startup trigger signal Sw_tr having the high voltage level is additionally outputted to the base terminal of the digital transistor 45, resulting in the digital transistor 45 being switched from the off state to the on state. This on state of the digital transistor 45 enables the zero-voltage level of the monitor signal to be outputted from the digital transistor 45 to the SoC 30.

When receiving the monitor signal having the zero-voltage level outputted from the digital transistor 45, the SoC 30 recognizes that this startup of the SoC 30 itself is due to the external ECU 7 in step S274 of the first reprogramming startup routine.

Additionally, the communication device 9 outputs updating information about the SoC 30 to the communication driver 20 through the communication line 55 in step S276 of the first reprogramming startup routine.

When starting up, the SoC 30 executes various programs including a startup program stored therein. Specifically, when executing the start-up program, the SoC 30 instructs the communication driver 20 to output the high-level voltage signal Sm to the first converter 41 through the first conductor wiring 61 in step S300 of the first reprogramming startup routine.

Specifically, as illustrated in FIG. 1, the SoC 30 outputs, to the communication driver 20 through the second conductor wiring 62, the first instruction signal that instructs the communication driver 20 to output the high-level voltage signal Sm. In response to receiving the first instruction signal, the communication driver 20 outputs the high-level voltage signal Sm to the first converter 41 through the first conductor wiring 61 and the third diode 83.

Accordingly, even if the voltage level of the startup trigger signal Sw_tr changes from the high level to the low level due to any cause, the high-level voltage signal Sm is inputted from the third diode 83 to the first converter 41 in place of the high-level startup trigger signal Sw_tr, making it possible to maintain, at the high level, the voltage signal for instructing the first converter 41 to convert the power voltage Vb to the voltage Vb1. This therefore results in the converted voltage Vb1 being continuously applied from the first converter 41 to the second converter 42, making it possible to maintain the startup of the SoC 30.

Following the operation in step S300, the SoC 30 acquires the voltage signal Sm from the communication driver 20 through the first conductor wiring 61 in step S302.

Next, the SoC 30 determines whether the voltage signal Sm acquired in step S302 has the high level to accordingly determine whether, as described later, the SoC 30 is permitted to shut down the external ECU 7 in step S304.

In response to determination that the voltage signal Sm acquired in step S302 does not have the high level (NO in step S304), the SoC 30 determines that the SoC 30 is not permitted to shut down the external ECU 7. That is, change of the startup trigger signal Sw_tr from the high level to the low level results in no high-level voltage signal being supplied to the first converter 41, so that, if the external ECU 7 were shut down, the SoC 30 would be shut down. For this reason, the SoC 30 determines that the SoC 30 is not permitted to shut down the external ECU 7 in response to the negative determination in step S304. Then, the first reprogramming startup routine returns to step S300.

In contrast, in response to determination that the voltage signal Sm acquired in step S302 has the high level (YES in step S304), the SoC 30 determines that the SoC 30 is permitted to shut down the external ECU 7. That is, even if the startup trigger signal Sw_tr is changed from the high level to the low level, the supply of the high-level voltage signal Sm to the first converter 41 is maintained, so that, even if the external ECU 7 were shut down, the SoC 30 would continuously operate. For this reason, the SoC 30 determines that the SoC 30 is permitted to shut down the external ECU 7 in response to the affirmative determination in step S304.

Following the operation in step S304, the SoC 30 shuts down the external ECU 7 in step S306. Specifically, the SoC 30 outputs, to the external ECU 7 through a communication line CL, a third instruction signal that instructs the external ECU 7 to change the voltage level of the startup trigger signal Sw_tr from the high level to the low level, and thereafter to shut itself down. In response to receiving the third instruction signal, the external ECU 7 changes the voltage level of the startup trigger signal Sw_tr from the high level to the low level, and thereafter resulting in shutting itself down in step S307 of the first reprogramming startup routine.

Following the operation in step S306, the SoC 30 executes an updating program stored therein to accordingly carry out the updating task, i.e., the OTA reprogramming task, of updating the software and/or information stored therein in accordance with the updating information acquired from the communication driver 20 in step S308, and thereafter terminates the first reprogramming startup routine. After the termination of the first reprogramming startup routine, the SoC 30 continuously carries out the updating task.

The startup, i.e., activation, of the SoC 30 in the first reprogramming startup routine, which is triggered by the external ECU 7, has been described.

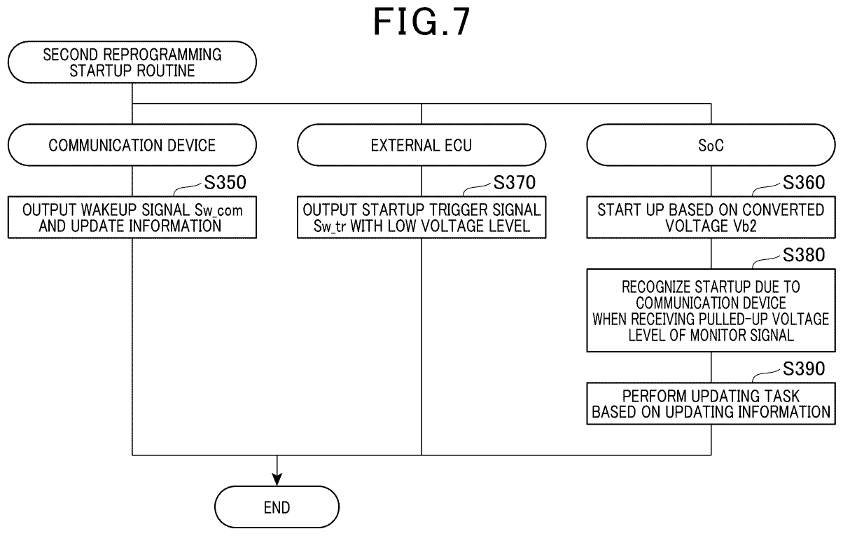

Next, the following describes a second reprogramming startup routine, which is triggered by the communication device 9 with reference to FIGS. 1 and 7.

For startup of the SoC 30, the communication device 9 outputs, to the communication driver 20, the wakeup signal Sw_com and the updating information about the SoC 30 in step S350 of the second reprogramming startup routine in FIG. 7. In response to receiving the wakeup signal Sw_com, the communication driver 20 outputs the high-level voltage signal Sm to the first converter 41 through the first conductor wiring 61 and the third diode 83. In response to receiving the high-level voltage signal Sm, the first converter 41 converts the power voltage Vb to the voltage Vb1, and supplies the converted voltage Vb1 to the second converter 42. In response to receiving the converted voltage Vb1, the second converter 42 adjusts the converted voltage Vb1 to the voltage Vb2 that enables start-up of the SoC 30. Then, the second converter 42 supplies the converted voltage Vb2 to the SoC 30. When receiving the converted voltage Vb2, the SoC 30 starts up in step S360.

At that time, the external ECU 7 outputs the startup trigger signal Sw_tr having the low voltage level to the base terminal of the digital transistor 45 in step S370 of the second reprogramming startup routine, resulting in the digital transistor 45 being maintained in the off state. The off state of the digital transistor 45 results in the pull-up voltage of the power source 85 being inputted to the SoC 30 as the monitor signal. This enables the SoC 30 to determine, based on the voltage level, i.e., the pull-up voltage level of the monitor signal, that no trigger signal Sw_tr with the high voltage level is outputted toward the SoC 30. When receiving the monitor signal having the pull-up voltage level from the digital transistor 45, the SoC 30 recognizes that the startup of the SoC 30 itself is due to the communication device 9 in step S380 of the second reprogramming startup routine.

In response to receiving the updating information, the communication driver 20 outputs, to the SoC 30, the updating information about the SoC 30.

In response to receiving the updating information, the SoC 30 executes the updating program stored therein to accordingly carry out the updating task, i.e., the OTA reprogramming task, of updating the software and/or information stored therein in accordance with the updating information acquired from the communication driver 20 in step S390 of the second reprogramming startup routine and thereafter terminates the second reprogramming startup routine. After the termination of the second reprogramming startup routine, the SoC 30 continuously carries out the updating task.

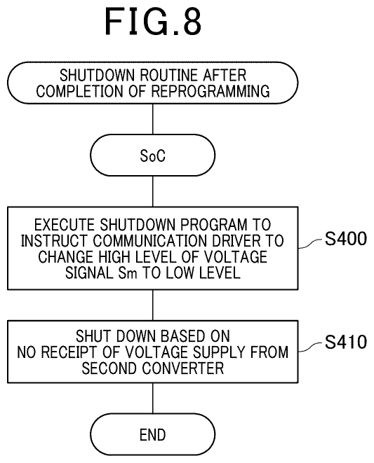

The startup, i.e., activation, of the SoC 30 in the second reprogramming startup routine, which is triggered by the communication device 9, has been described. Next, the following describes a shutdown routine after the OTA reprogramming task has been completed with reference to FIGS. 1 and 8.

During execution of the OTA reprogramming task triggered by any of the external ECU 7 and the communication device 9, the voltage level of the startup trigger signal Sw_tr is the high level, and the voltage level of the voltage signal Sm outputted from the communication driver 20 is the high level. For this reason, when completing the OTA reprogramming task, i.e., the updating task, the SoC 30 executes a shutdown program stored therein to accordingly output, to the communication driver 20 through the second conductor wiring 62, a fourth instruction signal that instructs the communication driver 20 to change the voltage level of the voltage signal Sm from the high level to the low level in step S400 of the shutdown routine after completion of the OTA reprogramming task in FIG. 8.

In response to receiving the voltage signal Sm with the high level, the communication driver 200 changes the voltage level of the voltage signal Sm from the high level to the low level, and outputs, to the first converter 41, the low-level voltage signal Sm through the first conductor wiring 61 and the third diode 83. In response to receiving the low-level voltage signal Sm, the first converter 41 stops conversion of the power voltage Vb, and stops voltage supply to the second converter 42, so that the second converter 42 stops both voltage adjustment and voltage supply to the SoC 30. When determining no receipt of the voltage supply from the second converter 42, the SoC 30 stops execution of the shutdown program, thereafter shutting itself down in step S410 of the shutdown routine after the OTA reprogramming task.

The shutdown, i.e., deactivation, of the SoC 30 after the OTA reprogramming task has been described.

Next, the following describes the smaller size of the ECU 10 of the exemplary embodiment.

The ECU 10 includes the SoC 30, the communication driver 20, and the converter module 40 comprised of the first and second converters 41 and 42. The SoC 30 serves as, for example, a processing unit that performs processing on one or more targets, such as one or more target information items and/or one or more controlled targets. For example, the SoC 30 performs an image-processing task based on images captured by the unillustrated one or more vehicular cameras.

The communication driver 20 serves as, for example, a communication unit that outputs the voltage signal Sm with the high voltage level when communicating with the communication device 9 using a predetermined communication protocol, such as the CAN protocol or LIN protocol, to accordingly receive the wakeup signal Sw_com from the communication device 9.

The converter module 40 is configured to apply, to the SoC 30, the voltage Vb2, i.e., a startup voltage, based on the power voltage Vb to start up the SoC 30 when receiving any one of (i) the startup trigger signal Sw_tr with the high voltage level outputted from the external ECU 7 and (ii) the high-level voltage signal Sm outputted from the communication driver 20. That is, the voltage controller 40 serves as, for example, a voltage controller for starting up the SoC 30.

Specifically, the first converter 41 is configured to convert the power voltage Vb to the voltage Vb1 in response to receiving any one of (i) the startup trigger signal Sw_tr with the high voltage level outputted from the external ECU 7 and (ii) the high-level voltage signal Sm outputted from the communication driver 20. Then, the first converter 41 is configured to supply the voltage Vb1 to the second converter 42, and the second converter 42 is configured to convert the converted voltage Vb1 to the startup voltage Vb2 to accordingly supply the startup voltage Vb2 to the SoC 30, resulting in the SoC 30 starting up.

Specifically, the wakeup signal Sw_com serves as, for example, a first startup signal for startup of the SoC 30, i.e., the processing unit, from the communication device 9, and the voltage signal Sm with the high voltage level serves as, for example, a second startup signal for startup of the SoC 30, i.e., the processing unit, from the communication driver 20, i.e., the communication unit. Additionally, the startup trigger signal Sw_tr with the high voltage level serves as, for example, a third startup signal for startup of the SoC 30, i.e., the processing unit, from an external device,

That is, the communication driver 20 is configured to have both (i) the first function of communicating with the communication device 9 and (ii) the second function of outputting the third startup signal for startup of the SoC 30. This configuration results in the first function and the second function being integrally installed in a single component, i.e., the communication driver 20, without being respectively installed in separate individual components, resulting in the ECU 10 having a smaller size.

The ECU 10 of the exemplary embodiment additionally achieves the following advantageous benefits.

The SoC 30 is configured to instruct the communication driver 20 to output, to the converter module 40, the voltage signal Sm with the high voltage level when starting up in response to receiving the startup trigger signal Sw_tr; the voltage signal Sm with the high voltage level serves as, for example, a control signal for supply of the startup voltage Vb2 to the SoC 30, i.e., the processing unit.

This configuration of the SoC 30 maintains, at the high level, the voltage level of the control signal for supply of the startup voltage Vb2 to the SoC 30 even if the high voltage level of the startup trigger signal Sw_tr is not maintained, such as the startup trigger signal Sw_tr is interrupted or the voltage level of the startup trigger signal Sw_tr becomes the low level. This maintains the voltage supply from the converter module 40 to the SoC 30, making it possible to maintain the startup of the SoC 30.

The SoC 30 is configured to instruct, as illustrated in steps S302, S304, and S306, the external ECU 7 to stop output of the startup trigger signal Sw_tr with the high voltage level upon determination that the high-level voltage signal Sm is outputted from the communication driver 20 to the converter module 40. For example, the SoC 30 is configured to output, to the external ECU 7, the third instruction signal that instructs the external ECU 7 to change the voltage level of the startup trigger signal Sw_tr from the high level to the low level. This instructs the external ECU 7 to be shut down. This therefore reduces power consumption due to, for example, unnecessary activation of the external ECU 7

The SoC 30 is configured to instruct the communication driver 20 to stop output of the high-level voltage signal Sm. For example, the SoC 30 is configured to instruct the communication driver 20 to change the voltage level of the voltage signal Sm from the high level to the low level.

This configuration enables the SoC 30 to be deactivated by itself, making it possible to reduce power consumption due to, for example, unnecessary activation of the SoC 30. For example, this configuration reduces power consumption due to, for example, unnecessary activation of the SoC 30 after updating of software and/or information stored in the SoC 30 has been completed, resulting in smaller power consumption of the ECU 10.

The present disclosure is not limited to the exemplary embodiment set forth above, and therefore can be freely modified. Components or elements constituting the exemplary embodiment are not necessarily essential components or elements unless (i) they are clearly described as essential components or elements or (ii) they are clearly essential components or elements in principle.

The processing unit and its processing method, the communication unit and its communication method, and the voltage controller and its control method disclosed in the present disclosure can be implemented by a dedicated computer including a memory and a processor programmed to perform one or more functions embodied by one or more computer programs.

The processing unit and its processing method, the communication unit and its communication method, and the voltage controller and its control method disclosed in the present disclosure can also be implemented by a dedicated computer including a processor comprised of one or more dedicated hardware logic circuits.

The processing unit and its processing method, the communication unit and its communication method, and the voltage controller and its control method disclosed in the present disclosure can further be implemented by a processor system comprised of a memory, a processor programmed to perform one or more functions embodied by one or more computer programs, and one or more hardware logic circuits.

The one or more computer programs can be stored in a non-transitory storage medium as instructions to be carried out by a computer or a processor.

In the first normal startup routine, the communication driver 20 of the exemplary embodiment is configured to output the high-level voltage signal Sm to the first converter 41 through the first conductor wiring 61 and the third diode 83 while the voltage level of the startup trigger signal Sw_tr is maintained at the high level. The present disclosure is however not limited to this configuration. Specifically, in the first normal startup routine, while the communication driver 20 outputting the high-level voltage signal Sm to the first converter 41 through the first conductor wiring 61 and the third diode 83, the SoC 30 can be configured to instruct the external ECU 7 to change the voltage level of the startup trigger signal Sw_tr from the high level to the low level. This modified configuration enables the external ECU 7 to be deactivated, making it possible to reduce power consumption due to, for example, unnecessary activation of the external ECU 7 and therefore to reduce power consumption of the ECU 10.

The converter module 40 of the exemplary embodiment, which is comprised of the first and second converters 41 and 42, is configured to convert the power voltage Vb to the startup voltage Vb2, and apply the startup voltage Vb2 to the SoC 30, but the converter module 40 is not limited to this configuration. Specifically, the converter module 40 can be comprised of the first converter 41, and the first converter 41 of the converter module 40 can be configured to convert the power voltage Vb to the startup voltage Vb2, and apply the startup voltage Vb2 to the SoC 30.

The present disclosure includes the following first to ninth technological concepts.

The first technical concept is an electronic control apparatus.

The electronic control apparatus includes a processing unit (30) configured to perform processing on one or more targets. The electronic control apparatus includes a communication unit (20) configured to communicate with a communication device (9) using a predetermined communication protocol to accordingly receive a first startup signal (Sw_com) for startup of the processing unit from the communication device. The communication unit is additionally configured to output, in response to receiving the first startup signal from the communication device, a second startup signal (Sm) for startup of the processing unit. The electronic control apparatus includes a voltage controller (40) configured to supply, in response to receiving one of the second startup signal and a third startup signal (Sw_tr) for startup of the processing unit outputted from an external device, a startup voltage based on a power voltage to the processing unit to accordingly start up the processing unit.

In the second technological concept, which depends from the first technological concept, the processing unit is configured to, when starting up based on the startup voltage supplied from the voltage controller in response to receiving the third startup signal (Sw_tr) from the external device, instruct the communication unit to output, to the voltage controller, a control signal (Sm) as the second startup signal, the control signal instructing the voltage controller to supply the startup voltage to the processing unit.

In the third technological concept, which depends from the second technological concept, the processing unit is configured to instruct the external device to stop output of the third startup signal (Sw_tr) while the control signal (Sm), which instructs the voltage controller to supply the startup voltage to the processing unit, is outputted from the communication unit to the voltage controller.

In the fourth technological concept, which depends from the third technological concept, the processing unit is configured to instruct the communication unit to stop output of the control signal (Sm), which instructs the voltage controller to supply the startup voltage to the processing unit, resulting in the processing unit shutting itself down.

In the fifth technological concept, which depends from the fourth technological concept, the processing unit stores software and/or information therein, and the processing unit is configured to (i) acquire, from the communication device through the communication unit, updating information, and (ii) perform an updating task of updating, based on the acquired updating information, the software and/or information stored therein, resulting in, after completion of the updating task, the processing unit shutting itself down.

In the sixth technological concept, which depends from the first technological concept, the voltage controller has both a first function of communicating with the communication device and a second function of supplying one of the second startup signal and the third startup signal to the processing unit for startup of the processing unit.

In the seventh technological concept, which depends from the first technological concept, the processing unit is programmed to (i) monitor whether the third startup signal is outputted from the external device thereto, (ii) determine that startup thereof is due to the external device upon determination that the third startup signal having a predetermined first level is outputted from the external device, and (iii) determine that startup thereof is due to the communication device upon determination that the third startup signal having a predetermined second level different from the first level is outputted from the external device.

The eighth technological concept, which depends from the first technological concept, further includes a digital transistor (45) connected between the external device and the processing unit. The digital transistor is configured to output, to the processing unit, a monitor signal whose level is changed depending on whether the digital transistor is turned on in response to receiving the third startup signal or is turned off in response to receiving no third startup signal. The processing unit is programmed to determine whether startup thereof is due to the external device or the communication device in accordance with the level of the monitor signal.

The ninth technical concept is a system. The system includes a processing unit configured to perform processing on one or more targets, and a communication device configured to output a first startup signal for startup of the processing unit. The system includes a communication unit configured to (i) communicate with the communication device to accordingly receive the first startup signal for startup of the processing unit from the communication device, and (ii) output, in response to receiving the first startup signal from the communication device, a second startup signal for startup of the processing unit.

The system includes an external device configured to output a third startup signal for startup of the processing unit, and a voltage controller configured to supply, in response to receiving one of the second startup signal and the third startup signal, a startup voltage based on a power voltage to the processing unit to accordingly start up the processing unit.

1. An electronic control apparatus comprising:
a processing unit configured to perform processing on one or more targets;
a communication unit configured to:
communicate with a communication device using a predetermined communication protocol to accordingly receive a first startup signal for startup of the processing unit from the communication device; and
output, in response to receiving the first startup signal from the communication device, a second startup signal for startup of the processing unit; and
a voltage controller configured to supply, in response to receiving one of the second startup signal and a third startup signal for startup of the processing unit outputted from an external device, a startup voltage based on a power voltage to the processing unit to accordingly start up the processing unit.

2. The electronic control apparatus according to claim 1, wherein:
the processing unit is configured to, when starting up based on the startup voltage supplied from the voltage controller in response to receiving the third startup signal from the external device, instruct the communication unit to output, to the voltage controller, a control signal as the second startup signal, the control signal instructing the voltage controller to supply the startup voltage to the processing unit.

3. The electronic control apparatus according to claim 2, wherein:
the processing unit is configured to instruct the external device to stop output of the third startup signal while the control signal, which instructs the voltage controller to supply the startup voltage to the processing unit, is outputted from the communication unit to the voltage controller.

4. The electronic control apparatus according to claim 3, wherein:
the processing unit is configured to instruct the communication unit to stop output of the control signal, which instructs the voltage controller to supply the startup voltage to the processing unit, resulting in the processing unit shutting itself down.

5. The electronic control apparatus according to claim 4, wherein:
the processing unit stores software and/or information therein;
the processing unit is configured to:
acquire, from the communication device through the communication unit, updating information; and
perform an updating task of updating, based on the acquired updating information, the software and/or information stored therein, resulting in, after completion of the updating task, the processing unit shutting itself down.

6. The electronic control apparatus according to claim 1, wherein:
the voltage controller has both a first function of communicating with the communication device and a second function of supplying one of the second startup signal and the third startup signal to the processing unit for startup of the processing unit.

7. The electronic control apparatus according to claim 1, wherein:
the processing unit is programmed to:
monitor whether the third startup signal is outputted from the external device thereto; and
determine that startup thereof is due to the external device upon determination that the third startup signal having a predetermined first level is outputted from the external device; and
determine that startup thereof is due to the communication device upon determination that the third startup signal having a predetermined second level different from the first level is outputted from the external device.

8. The electronic control apparatus according to claim 1, further comprising:
a digital transistor connected between the external device and the processing unit,
the digital transistor being configured to output, to the processing unit, a monitor signal whose level is changed depending on whether the digital transistor is turned on in response to receiving the third startup signal having a predetermined first level or is turned off in response to receiving the third startup signal having a predetermined second level different from the predetermined first level,
the processing unit being programmed to determine whether startup therefor is due to the external device or the communication device in accordance with the level of the monitor signal.

9. A system comprising:
a processing unit configured to perform processing on one or more targets;
a communication device configured to output a first startup signal for startup of the processing unit;
a communication unit configured to:
communicate with the communication device to accordingly receive the first startup signal for startup of the processing unit from the communication device; and
output, in response to receiving the first startup signal from the communication device, a second startup signal for startup of the processing unit;
an external device configured to output a third startup signal for startup of the processing unit; and
a voltage controller configured to supply, in response to receiving one of the second startup signal and the third startup signal, a startup voltage based on a power voltage to the processing unit to accordingly start up the processing unit.
